(19) United States
(12) Patent Application Publication
(10) Pub. No.: US 2024/0417219 A1
(43) Pub. Date: Dec. 19, 2024

(54) BRAKE CIRCUIT ACCESS FROM LANDING

(71) Applicant: Otis Elevator Company, Farmington, CT (US)

(72) Inventors: Bennie Murah, Timmonsville, SC (US); Paul Cornett, Florence, SC (US)

(21) Appl. No.: 18/336,582

(22) Filed: Jun. 16, 2023

(51) Int. Cl. B66B 13/30; B66B 1/06; B66B 19/00

(52) U.S. Cl. CPC B66B 13/306; B66B 1/06; B66B 19/00

(57) ABSTRACT

A method of operating an elevator system is provided and includes opening a door of a door jamb at a landing of the elevator system to reveal an upper panel and a cover of a lower panel which are disposed in a cavity defined in the door jamb, unlocking and opening the cover, removing the lower panel from the cavity and accessing and controlling one or more electrical and/or electro-mechanical elevator components using the lower panel.

### BACKGROUND

The present disclosure relates to elevator systems and, in particular, to a system and method that provide for brake circuit access from an elevator system landing.

In an elevator system, a hoistway is built into a building and an elevator car travels up and down along the hoistway to arrive at landing doors of different floors of the building. The movement of the elevator is driven by a machine that is controlled by a controller according to instructions received from users of the elevator system. At each floor, the landing doors can be opened to allow one or more passengers to move from the corresponding landing into the elevator car or from the elevator car to the corresponding landing.

### SUMMARY

According to an aspect of the disclosure, a method of operating an elevator system is provided and includes opening a door of a door jamb at a landing of the elevator system to reveal an upper panel and a cover of a lower panel which are disposed in a cavity defined in the door jamb, unlocking and opening the cover, removing the lower panel from the cavity and accessing and controlling one or more electrical and/or electro-mechanical elevator components using the lower panel.

In accordance with additional or alternative embodiments, the method further includes redesigning the door jamb, where the redesigning of the door jamb includes extending the cavity to below the upper panel to accommodate the lower panel and extending the door to cover respective entireties of the upper panel, the cover and the lower panel.

In accordance with additional or alternative embodiments, the upper panel includes an intercommunication panel.

In accordance with additional or alternative embodiments, the unlocking and opening the cover includes unlocking a keyed lock.

In accordance with additional or alternative embodiments, the removing of the lower panel from the cavity includes rotating lower panel away from the upper panel, sliding a lower panel mounting bracket out of the cavity and removing a lower panel cover from the lower panel.

In accordance with additional or alternative embodiments, the lower panel includes a printed circuit board assembly (PCBA) for accessing and controlling one or more electrical and/or electro-mechanical elevator components.

In accordance with additional or alternative embodiments, the lower panel includes one or more brake relays, one or more additional relays and one or more electrical elements.

In accordance with additional or alternative embodiments, the one or more electrical elements include at least one or more fuses, one or more LEDs, one or more jumpers, one or more diodes and one or more varistors.

According to an aspect of the disclosure, a door jamb of an elevator system is provided and includes a bulkhead formed to define a cavity and comprising a door covering the cavity and an upper panel, a lower panel and a cover of the lower panel disposed in the cavity. The lower panel is removable from the cavity with the door opened and the cover being unlocked and opened. The lower panel includes a printed circuit board assembly (PCBA) for accessing and controlling one or more electrical and/or electro-mechanical elevator components.

In accordance with additional or alternative embodiments, the cavity is configured to accommodate the upper panel, the lower panel and the cover and the door is configured to extend over respectively entireties of the upper panel, the cover and the lower panel.

In accordance with additional or alternative embodiments, the upper panel includes an intercommunication panel.

In accordance with additional or alternative embodiments, the cover is positioned over the lower panel and locked in place by a keyed lock.

In accordance with additional or alternative embodiments, the lower panel is removable from the cavity by being rotated away from the upper panel, a mounting bracket thereof being slid out of the cavity and a lower panel cover thereof being removed.

In accordance with additional or alternative embodiments, the lower panel includes one or more brake relays, one or more additional relays and one or more electrical elements and the one or more electrical elements include at least one or more fuses, one or more LEDs, one or more jumpers, one or more diodes and one or more varistors.

According to an aspect of the disclosure, an elevator system is provided and includes a landing, a door jamb at the landing, the door jamb being formed to define a cavity and comprising a door covering the cavity and an upper panel, a lower panel and a cover of the lower panel disposed in the cavity. The lower panel is removable from the cavity with the door opened and the cover being unlocked and opened. The lower panel includes a printed circuit board assembly (PCBA) for accessing and controlling one or more electrical and/or electro-mechanical elevator components.

In accordance with additional or alternative embodiments, the cavity is configured to accommodate the upper panel, the lower panel and the cover and the door is configured to extend over respectively entireties of the upper panel, the cover and the lower panel.

In accordance with additional or alternative embodiments, the upper panel includes an intercommunication panel.

In accordance with additional or alternative embodiments, the cover is normally screw-fastened over the lower panel and locked in place by a keyed lock.

In accordance with additional or alternative embodiments, the lower panel is removable from the cavity by being rotated away from the upper panel, a mounting bracket thereof being slid out of the cavity and a lower panel cover thereof being removed.

In accordance with additional or alternative embodiments, the lower panel includes one or more brake relays, one or more additional relays and one or more electrical elements and the one or more electrical elements include at least one or more fuses, one or more LEDs, one or more jumpers, one or more diodes and one or more varistors.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1A is a perspective view of an elevator system in accordance with one or more embodiments;

FIG. 1B is a perspective view of certain components of the elevator system of FIG. 1A in accordance with one or more embodiments;

FIG. 2A is a perspective view of a door jamb of an elevator system at a landing in accordance with one or more embodiments;

FIG. 2B is a top-down view of components of an elevator system including the door jamb of FIG. 2A in accordance with one or more embodiments;

FIG. 3 is a perspective view of a cover of a lower panel of the elevator system of FIGS. 2A and 2B in accordance with one or more embodiments;

FIG. 4 is an exploded perspective view of a lower panel having been removed from a cavity of a door jamb of the elevator system of FIGS. 2A and 2B in accordance with one or more embodiments;

FIG. 5 is a schematic diagram illustrating components of the lower panel of FIG. 4 in accordance with one or more embodiments; and

FIG. 6 is a flow diagram illustrating a method of operating an elevator system, such as the elevator system of FIGS. 2A, 2B and 3-5, in accordance with one or more embodiments.

### DETAILED DESCRIPTION

In elevator systems, when certain maintenance actions are called for, it is often necessary for a technician to access controlling circuitry that controls certain electrical elevator system operations. In machine room-less elevator systems, this controlling circuitry is housed in the hoistway-side of the door jamb at one of the elevator landings (i.e., the uppermost landing). Access to the controlling circuitry by the technician is enabled by the elevator car being placed just below the controlling circuitry in the corresponding hoistway whereupon the technician can climb to the roof of the elevator car to obtain the access. The process of enabling technician access to the controlling circuitry housed in the hoistway-side of the door jamb is therefore complicated and dependent on the ability of the elevator car to be moved into its position for the technician to stand on its roof.

Thus, as will be described below, an elevator system and a method of operating the elevator system are provided such that it is not necessary for a technician to stand on the roof of an elevator car in order to access controlling circuitry. Instead, a printed circuit board assembly (PCBA) is created for brake relays, brake circuits and supporting circuits and this PCBA is mounted to a bracket assembly through the door jamb, just below the I&T panel. The door that would otherwise hide the I&T panel is lengthened to accommodate the PCBA. The PCBA allows components of the elevator system, such as the brake control assemblies, to be accessed by a technician. Such accessed is obtained by the technician while the technician is standing in the landing by the technician opening the door, detaching a cover that is placed and locked over the PCBA and then fully removing the PCBA from its stowed position.

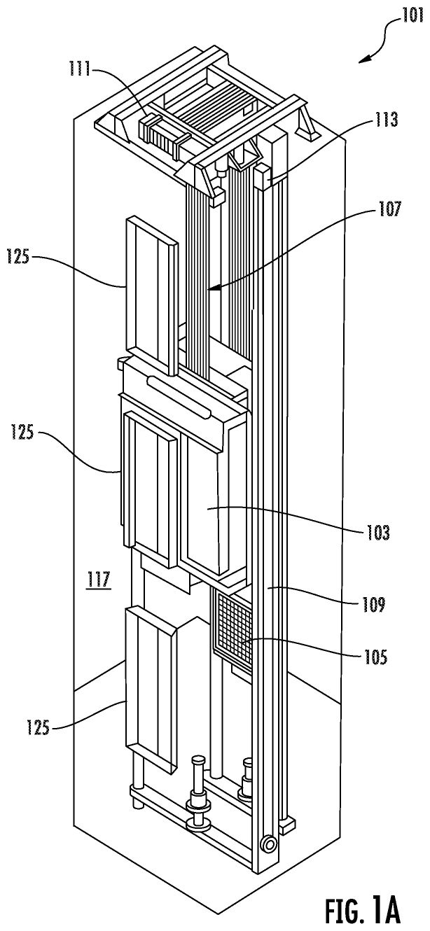

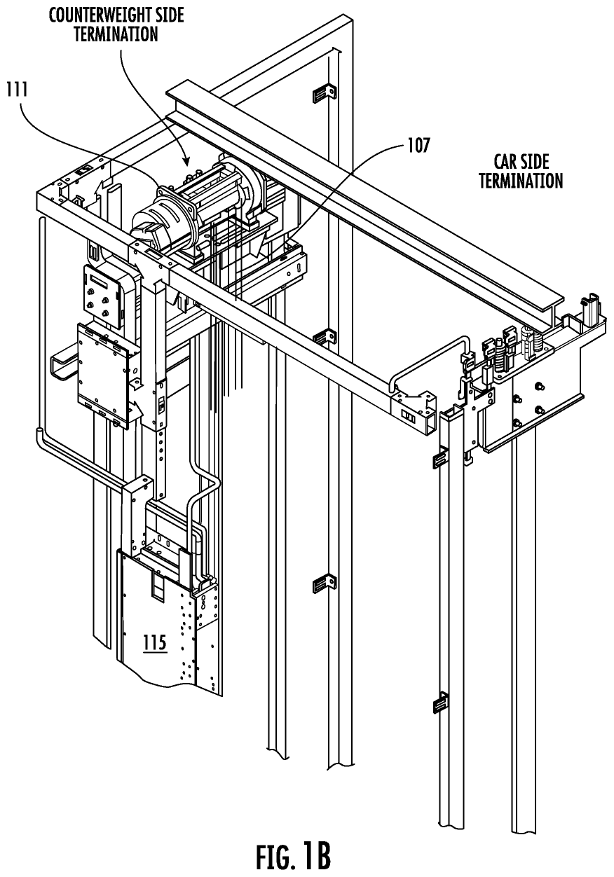

With reference to FIGS. 1A and 1B, which are perspective views of an elevator system 101 and components of the elevator system 101, the elevator system 101 includes an elevator car 103, a counterweight 105, a suspension member 107, a guide rail 109, a machine 111 and a controller 115. The elevator car 103 and the counterweight 105 are connected to each other by the tension member 107. The tension member 107 may include or be configured as, for example, ropes, steel cables and/or coated-steel belts. The counterweight 105 is configured to balance a load of the elevator car 103 (typically about the car mass+about 45% to about 50% duty load) and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control elevator car 103 movement, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be provided as a hoistway mounted control or as a machine room-less controller and is configured to control the operation of the elevator system 101, and particularly the elevator car 103. It is to be appreciated that the controller 115 need not be in a controller room 121 may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from a position reference system (not shown) or any other desired position reference device. When moving up or down within the elevator shaft 117 along guide rail 109, the elevator car 103 may stop at one or more landings 125 as controlled by the controller 115. Those of skill in the art will appreciate that the controller 115 can be located and/or configured in other locations or positions within the elevator system 101. In one embodiment, the controller 115 may be located remotely.

The machine 111 may include a motor or similar driving mechanism. In accordance with an embodiment of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

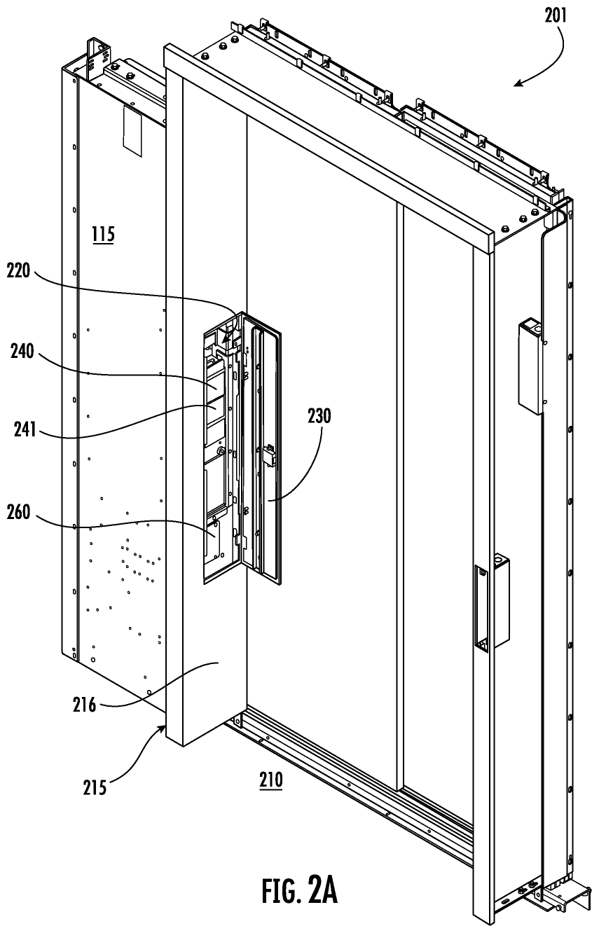

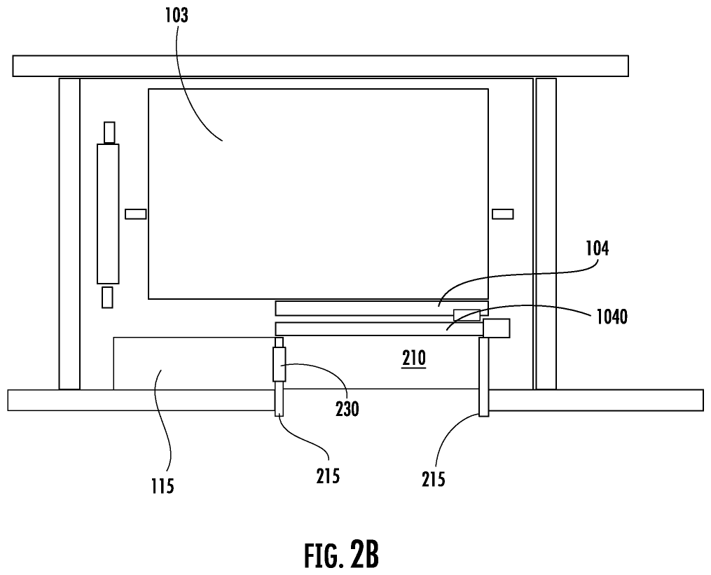

The elevator system 101 also includes one or more elevator doors 104 and one or more hoistway doors 1040 (see FIG. 2B). The elevator doors 104 may be integrally attached to the elevator car 103. The hoistway doors 1040 may be located on a landing 125 of the elevator system 101. The elevator doors 104 and the hoistway doors 1040 open to allow passengers to enter and exit the elevator car 103.

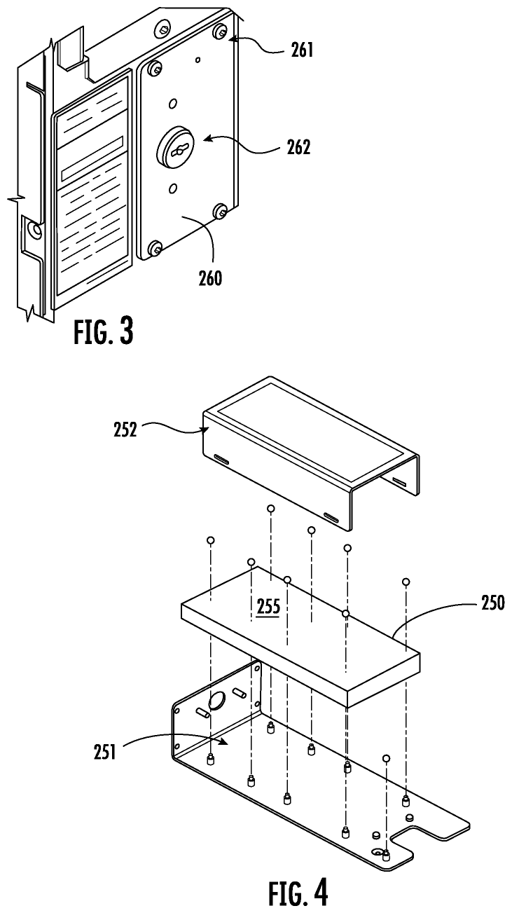

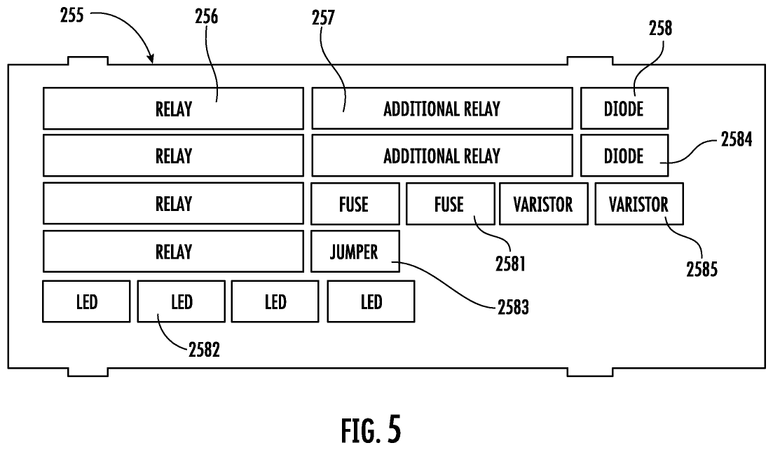

With continued reference to FIGS. 1A and 1B and with additional reference to FIGS. 2A and 2B and FIGS. 3-5, an elevator system 201 is provided for use with the elevator system 101 of FIGS. 1A and 1B for example. The elevator system 201 includes a landing 210 at which a passenger can access an elevator car, such as elevator car 103 of FIG. 1 by way of elevator doors 104 and hoistway doors 1040 of FIG. 2B. The landing 210 includes a door jamb 215 located at the landing 210. The door jamb 215 includes a bulkhead 216. The bulkhead 216 is formed to define a cavity 220 and includes a door 230, which can occupy at least open and closed positions. In the closed position, the door 230 covers and prevents access to the cavity 220 from the landing 210 and, in the open position, the door 230 permits access to the cavity 220 from the landing 210.

The elevator system 201 further includes an upper panel 240, such as an intercommunication panel 241, a lower panel 250 and a cover 260 of the lower panel 250, all of which are normally disposed in the cavity 220 and covered by the door 230 in the closed position. The cavity 220 is configured to accommodate the upper panel 240, the lower panel 250 and the cover 260. The door 230 is configured to extend over respectively entireties of the upper panel 240, the cover 260 and the lower panel 250. The cover 260 is normally screw-fastened over the lower panel 250 by screws 261 or other fasteners and locked in place by a keyed lock 262 that can only be opened by a person with the correct key, such as an authorized technician.

The lower panel 250 is removable from the cavity 220 with the door 230 opened to the open position and with the cover 262 being unlocked and opened. The lower panel 250 can be removable from the cavity 220 by the lower panel 250 being rotated away from the upper panel 240 (i.e., pivoted about a lower side of the lower panel 250), a mounting bracket 251 of the lower panel 250 being slid out of the cavity 220 and a lower panel cover 252 of the lower panel 250 being removed from the mounting bracket 251 and the lower panel 250.

The lower panel 250 can include a PCBA 255 that is configured for accessing and controlling of one or more electrical and/or electro-mechanical elevator components by a technician positioned at the landing 210. The lower panel 250 can include one or more brake relays 256, one or more additional relays 257 and one or more electrical elements 258. The one or more electrical elements 258 can include one or more fuses 2581, one or more LEDs 2582, one or more jumpers 2583, one or more diodes 2584 and one or more varistors 2585.

In accordance with one or more embodiments, two brakes are required for redundancy. Each brake is controlled by a relay or solid-state control. A third relay or solid-state control is in series with both brake control circuits for additional redundancy. Each brake can stop and hold the elevator car from moving. Fuses are used to protect the wiring and devices in the event of a short to ground or other failure. In the event of a power failure or major component failure the brakes can be controlled with separate circuits to manually lift the brakes and move the elevator car to a door to evacuate passengers. Once passengers have been evacuated, the manual circuits can be used to position the elevator to give access to the hoistway mounted controller components.

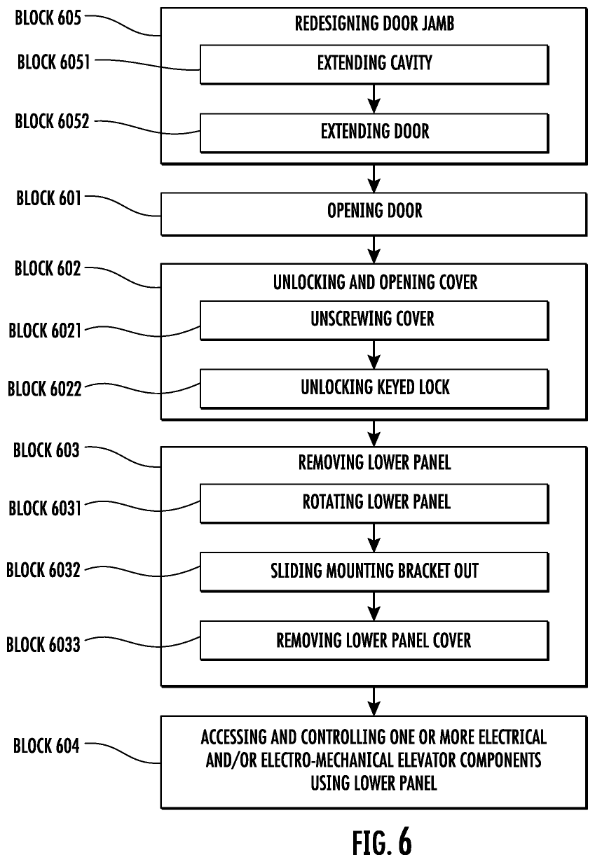

With reference to FIG. 6, a method of operating an elevator system, such as the elevator system 201 of FIGS. 2A, 2B and 3-5, is provided. The method includes opening a door of a door jamb at a landing of the elevator system to reveal an upper panel, such as an intercommunication panel, and a cover of a lower panel which are disposed in a cavity defined in the door jamb (block 601), unlocking and opening the cover (block 602), removing the lower panel from the cavity (block 603) and accessing and controlling one or more electrical and/or electro-mechanical elevator components using the lower panel (block 604).

As described above, the lower panel can include a PCBA for accessing and controlling one or more electrical and/or electro-mechanical elevator components and can include one or more brake relays or brake circuits, one or more additional relays and one or more electrical elements such as one or more fuses, one or more LEDs, one or more jumpers, one or more diodes and one or more varistors.

The method can further include an initial operation of redesigning the door jamb (block 605) by extending the cavity to below the upper panel to accommodate the lower panel (block 6051) and extending the door to cover respective entireties of the upper panel, the cover and the lower panel (block 6052). The unlocking and opening of the cover of block 602 can include unscrewing the cover from a mounting (block 6021) and unlocking a keyed lock (block 6022). The removing of the lower panel from the cavity of block 603 can include rotating lower panel away from the upper panel (block 6031), sliding a lower panel mounting bracket out of the cavity (block 6032) and removing a lower panel cover from the mounting bracket and the lower panel (block 6033).

Technical effects and benefits of the present disclosure are the provision of an elevator system in which a technician can access and control certain electrical and/or electro-mechanical elevator components while standing in a landing.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A method of operating an elevator system, the method comprising:
opening a door of a door jamb at a landing of the elevator system to reveal an upper panel and a cover of a lower panel which are disposed in a cavity defined in the door jamb;
unlocking and opening the cover;
removing the lower panel from the cavity; and
accessing and controlling one or more electrical and/or electro-mechanical elevator components using the lower panel.

2. The method according to claim 1, further comprising redesigning the door jamb, where the redesigning of the door jamb comprises:
extending the cavity to below the upper panel to accommodate the lower panel; and
extending the door to cover respective entireties of the upper panel, the cover and the lower panel.

3. The method according to claim 1, wherein the upper panel comprises an intercommunication panel.

4. The method according to claim 1, wherein the unlocking and opening the cover comprises unlocking a keyed lock.

5. The method according to claim 1, wherein the removing of the lower panel from the cavity comprises:
rotating lower panel away from the upper panel;
sliding a lower panel mounting bracket out of the cavity; and
removing a lower panel cover from the lower panel.

6. The method according to claim 1, wherein the lower panel comprises a printed circuit board assembly (PCBA) for accessing and controlling one or more electrical and/or electro-mechanical elevator components.

7. The method according to claim 1, wherein the lower panel comprises one or more brake relays, one or more additional relays and one or more electrical elements.

8. The method according to claim 7, wherein the one or more electrical elements comprise at least one or more fuses, one or more LEDs, one or more jumpers, one or more diodes and one or more varistors.

9. A door jamb of an elevator system, the door jamb comprising:
a bulkhead formed to define a cavity and comprising a door covering the cavity; and
an upper panel, a lower panel and a cover of the lower panel disposed in the cavity,
the lower panel being removable from the cavity with the door opened and the cover being unlocked and opened, and
the lower panel comprising a printed circuit board assembly (PCBA) for accessing and controlling one or more electrical and/or electro-mechanical elevator components.

10. The elevator system according to claim 9, wherein:
the cavity is configured to accommodate the upper panel, the lower panel and the cover, and
the door is configured to extend over respectively entireties of the upper panel, the cover and the lower panel.

11. The elevator system according to claim 9, wherein the upper panel comprises an intercommunication panel.

12. The elevator system according to claim 9, wherein the cover is normally positioned over the lower panel and locked in place by a keyed lock.

13. The elevator system according to claim 9, wherein the lower panel is removable from the cavity by being rotated away from the upper panel, a mounting bracket thereof being slid out of the cavity and a lower panel cover thereof being removed.

14. The elevator system according to claim 9, wherein:
the lower panel comprises one or more brake relays, one or more additional relays and one or more electrical elements, and
the one or more electrical elements comprise at least one or more fuses, one or more LEDs, one or more jumpers, one or more diodes and one or more varistors.

15. An elevator system, comprising:
a landing;
a door jamb at the landing, the door jamb being formed to define a cavity and comprising a door covering the cavity; and
an upper panel, a lower panel and a cover of the lower panel disposed in the cavity,
the lower panel being removable from the cavity with the door opened and the cover being unlocked and opened, and
the lower panel comprising a printed circuit board assembly (PCBA) for accessing and controlling one or more electrical and/or electro-mechanical elevator components.

16. The elevator system according to claim 15, wherein the cavity is configured to accommodate the upper panel, the lower panel and the cover and the door is configured to extend over respectively entireties of the upper panel, the cover and the lower panel.

17. The elevator system according to claim 15, wherein the upper panel comprises an intercommunication panel.

18. The elevator system according to claim 15, wherein the cover is normally screw-fastened over the lower panel and locked in place by a keyed lock.

19. The elevator system according to claim 15, wherein the lower panel is removable from the cavity by being rotated away from the upper panel, a mounting bracket thereof being slid out of the cavity and a lower panel cover thereof being removed.

20. The elevator system according to claim 15, wherein:
the lower panel comprises one or more brake relays, one or more additional relays and one or more electrical elements, and
the one or more electrical elements comprise at least one or more fuses, one or more LEDs, one or more jumpers, one or more diodes and one or more varistors.
